(19) United States
(12) Patent Application Publication
(10) Pub. No.: US 2011/0307834 A1
(43) Pub. Date: Dec. 15, 2011

(54) User Interface and Electronic Device

(76) Inventor: Chain -Long Wu, Hsinchu (TW)

(21) Appl. No.: 12/873,325

(22) Filed: Sep. 1, 2010

(30) Foreign Application Priority Data
Jun. 15, 2010 (TW) 099119482

(51) Int. Cl. G06F 3/048

(52) U.S. Cl. 715/836

(57) ABSTRACT

A user interface for an electronic device having a monitor includes a geometric polyhedron and a plurality of selecting objects. The geometric polyhedron is shown on the monitor, and composed of a plurality of blocks. Blocks of the plurality of blocks in a surface of the geometric polyhedron are capable of rotating along a center axle, and in an initial state, blocks corresponding to all surfaces of the geometric polyhedron have different colors. The plurality of selecting objects are shown on the plurality of blocks and corresponding to a plurality of functions of the electronic device.

### BACKGROUND OF THE INVENTION

1. Field of the Invention

The present invention relates to a user interface and electronic device, and more particularly, to a user interface and electronic device capable of providing an intuitive operating method with interest and interactivity.

2. Description of the Prior Art

In a portable electronic device, such as Personal Digital Assistant (PDA), smart phone, portable video player, etc., a touch panel is widely used as a main input device, such that user only needs to click selecting objects on the touch panel by a stylus or a finger, to execute corresponding programs, application software, etc. However, these selecting objects are generally displayed as a matrix, such that only limited selecting objects can be displayed within one frame, and such an interface is too dull and lack of personalized design. Moreover, specific functions cannot be easily found out due to too many menu layers, which reduce convenience.

For example, please refer to FIG. 1A to FIG. 1D. FIG. 1A to FIG. 1D are schematic diagrams of operations of a conventional smart phone 10. When a user attempts to utilize the smart phone 10 to play music, the user needs to click a “Start” menu first as shown in FIG. 1A, and then click “Programs” within the “Start” menu as shown in FIG. 1B; afterwards, the user needs to click a scroll of the “Programs” to display “Music Player” icon as shown in FIG. 1C; at last, the user clicks the “Music Player” icon as shown in FIG. 1D, to trigger music player software to play music.

As can be seen from the above, the conventional operating interface of the touch panel is lack of personalized design, such that the user cannot change locations of the main menu according to personal preferences or demands, and cannot find out specific functions due to too many menu layers.

### SUMMARY OF THE INVENTION

It is therefore an objective of the present invention to provide a user interface and electronic device.

The present invention discloses a user interface for an electronic device having a monitor. The user interface includes a geometric polyhedron, shown on the monitor, composed of a plurality of blocks, blocks of the plurality of blocks in a surface of the geometric polyhedron capable of rotating along a center axle of the surface, and a plurality of selecting objects, shown on the plurality of blocks, corresponding to a plurality of functions of the electronic device.

The present invention further discloses an electronic device. The electronic device includes an operating circuit, a monitor, and a user interface. The user interface includes a geometric polyhedron, shown on the monitor, composed of a plurality of blocks, blocks of the plurality of blocks in a surface of the geometric polyhedron capable of rotating along a center axle of the surface, and a plurality of selecting objects, shown on the plurality of blocks, corresponding to a plurality of functions of the operating circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A to FIG. 1D are schematic diagrams of operations of a conventional smart phone.

FIG. 2 is a schematic diagram of a user interface according to an embodiment of the present invention.

FIG. 3A, 3B, 4A to 4E, 5A, 5B, 6A to 6D and 7A to 7E are schematic diagrams of operations of the user interface in FIG. 2.

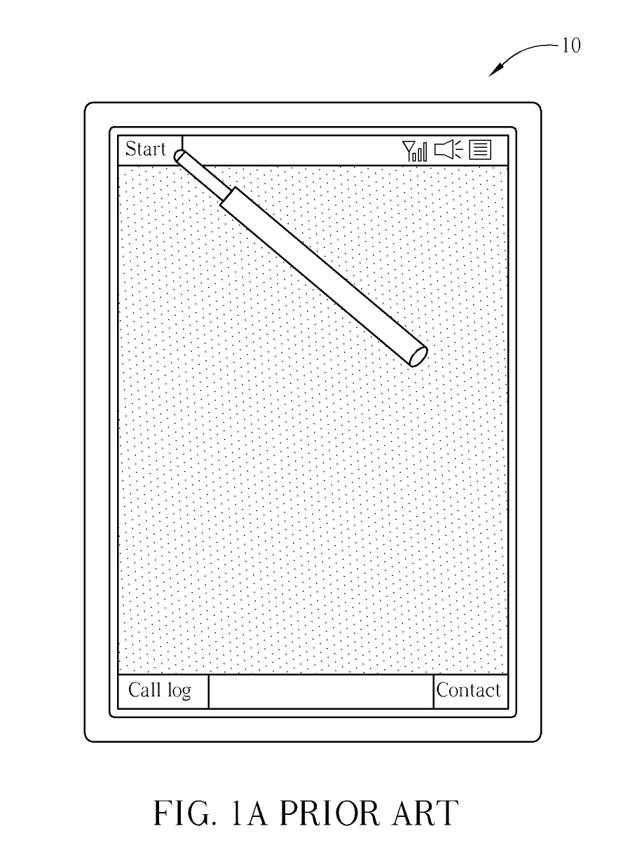

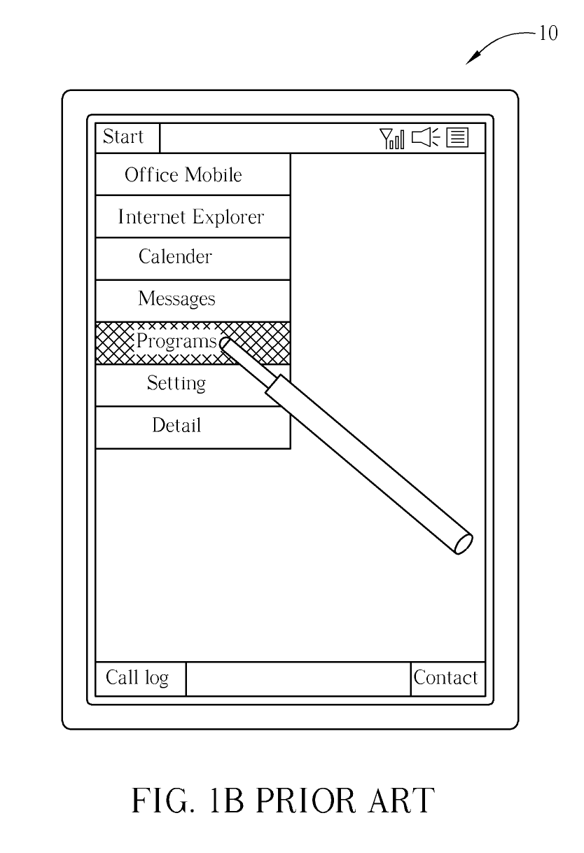

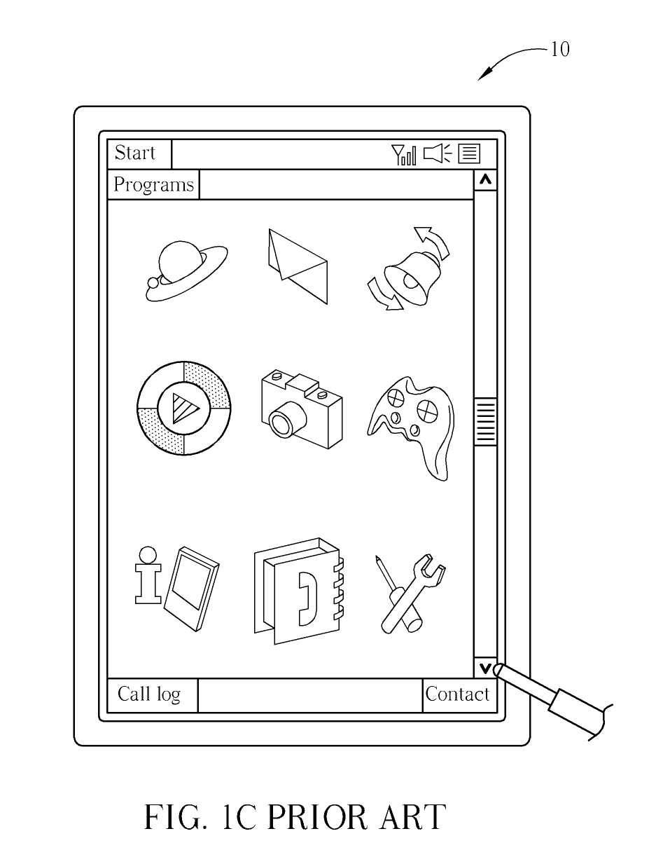

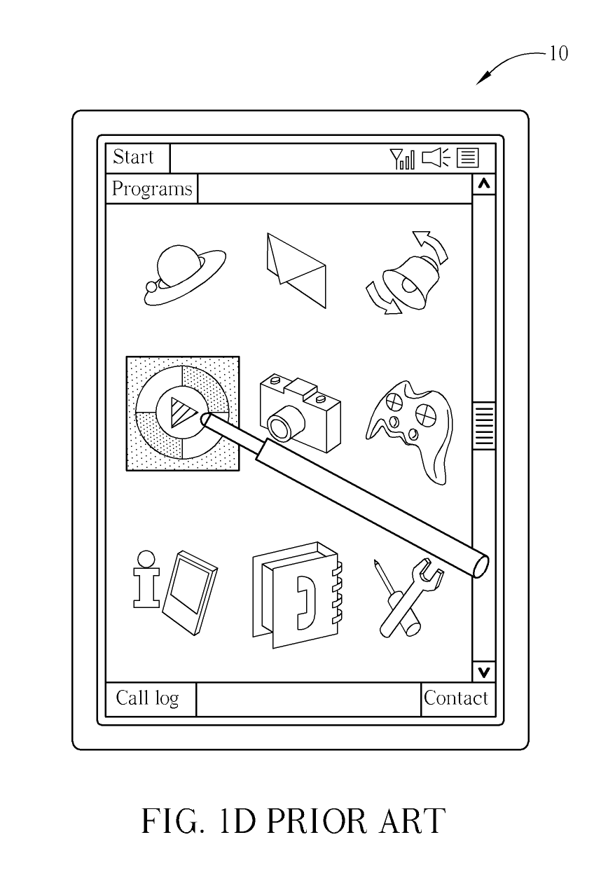

### DETAILED DESCRIPTION

In order to enhance interest of the user interface of a portable electronic device, while meet requirements of practicality and demands for personalization, the present invention introduces a user interface utilizing a Rubik's Cube as main image. As everyone knows, Rubik's Cube is one of the well-known puzzle toys in the world. The most common Rubik's Cube is a cube composed of third-order (3*3*3) blocks, i.e. 1 center axle, 6 center blocks, 12 side blocks and 8 corner blocks, which can be firmly fastened with each other without falling apart when being assembled together, and each surface of the Rubik's Cube can rotate along the center axle without affecting other blocks.

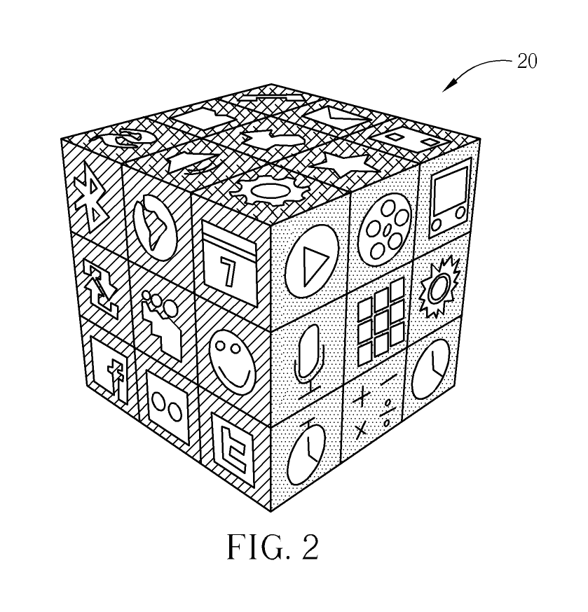

Please refer to FIG. 2, which is a schematic diagram of a user interface 20 according to an embodiment of the present invention. The user interface 20 is shown on a monitor of an electronic device, which can be a Personal Digital Assistant (PDA), a smart phone, a portable video player, etc., and the monitor is preferably, but not limited to, a touch panel. The user interface 20 is utilized for controlling different functions of the electronic device, and is mainly composed of a third-order Rubik's Cube and a plurality of selecting objects shown on the Rubik's Cube. Each selecting object is utilized for activating or controlling a specific function, such as Bluetooth, calendar, contact, map, Internet explore, etc., and is denoted by a non-filled icon. For simplicity, each selecting object in FIG. 2 is not denoted by a symbol. Noticeably, in the present invention, functions controlled by the user interface 20 should be properly adjusted according to different system requirements, and are not limited to the exemplary embodiment of FIG. 2.

In detail, the Rubik's Cube of the user interface 20 in FIG. 2 includes six surfaces, where blocks in a same surface has a same background color and blocks in different surfaces have different background colors in an initial state, which conforms to definitions of a conventional Rubik's Cube. Moreover, in order to denote different background colors, in FIG. 2 and following figures, different textures are utilized for denoting different background colors of blocks. For example, diagonal texture denotes blue background color, mesh texture denotes red background color, dot texture denotes yellow background color, cross line texture denotes green background color, horizontal line texture denotes orange background color, blank texture denotes white background color. Certainly, in the user interface 20, background colors shown by the Rubik's Cube are not limited to the above six colors, and can be adjusted according to system design or user demands as well.

As can be seen from FIG. 2, in the initial state, the user interface 20 can show 27 selecting objects at the same time. In other words, in a same image, the user can click to select 27 functions of a smart phone. If controllable functions of the smart phone are less than 27 or the user interface 20 is adjusted by the user, the user interface 20 can show selecting objects less than 27 as well, and blocks not showing selecting objects only have background colors.

Therefore, by utilizing the user interface 20, the user can quickly click to select a wanted selecting object without entering a lot of menu layers, which increases convenience. More importantly, the present invention utilizes the Rubik's Cube as the menu interface, which provides an intuitive operating method with interest and interactivity, so as to improve user-friendliness and significantly enhance operating efficiency.

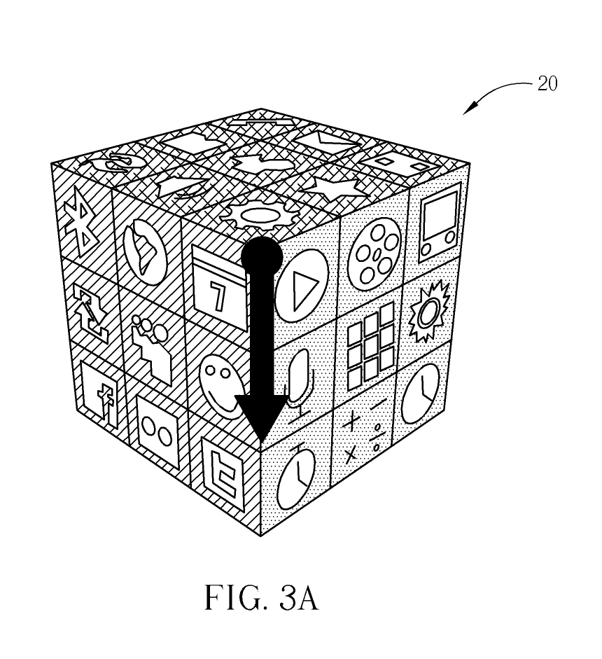

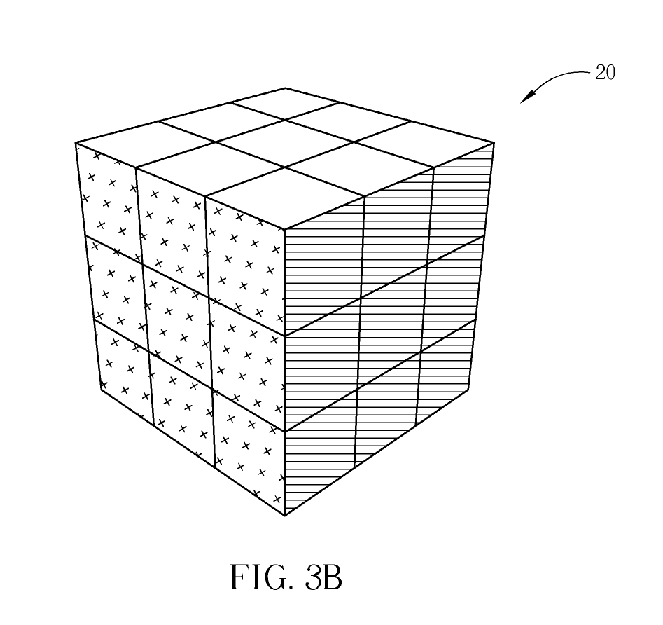

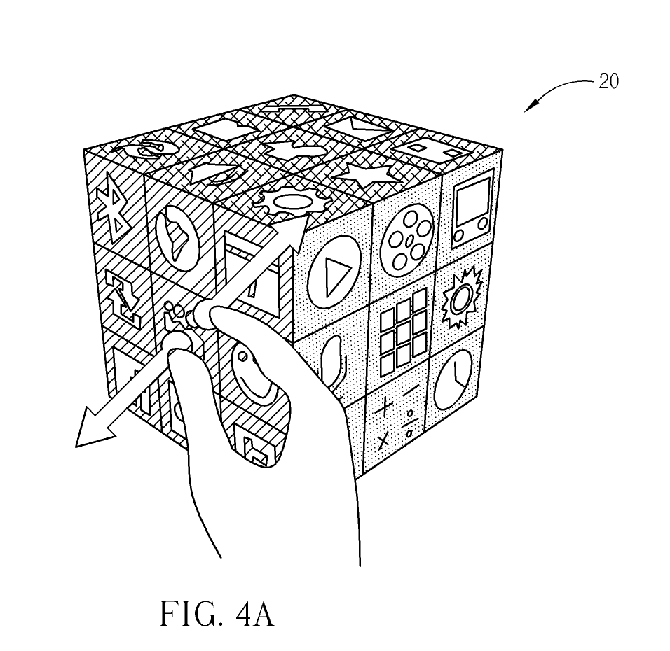

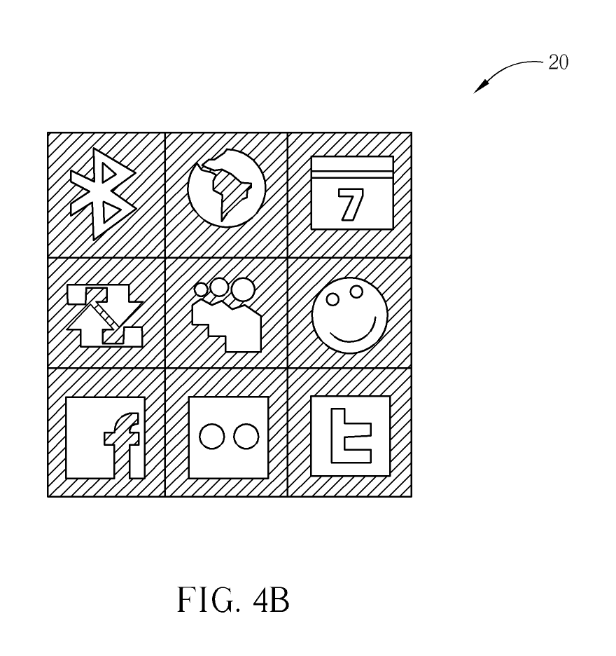

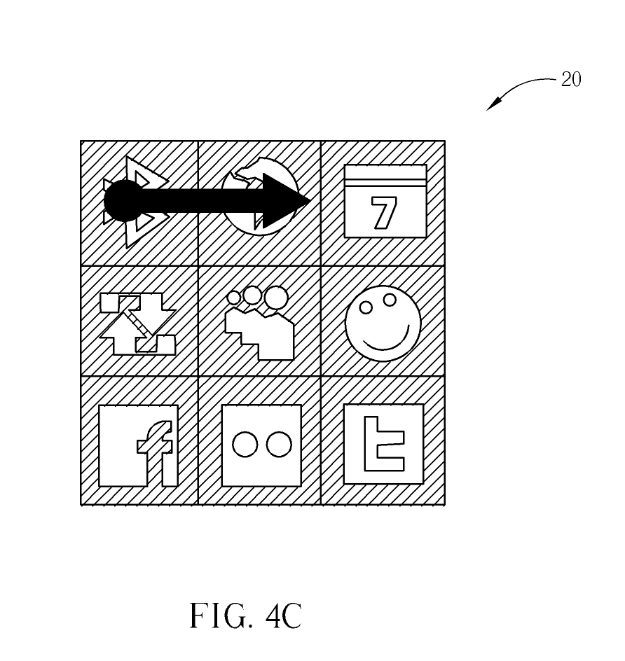

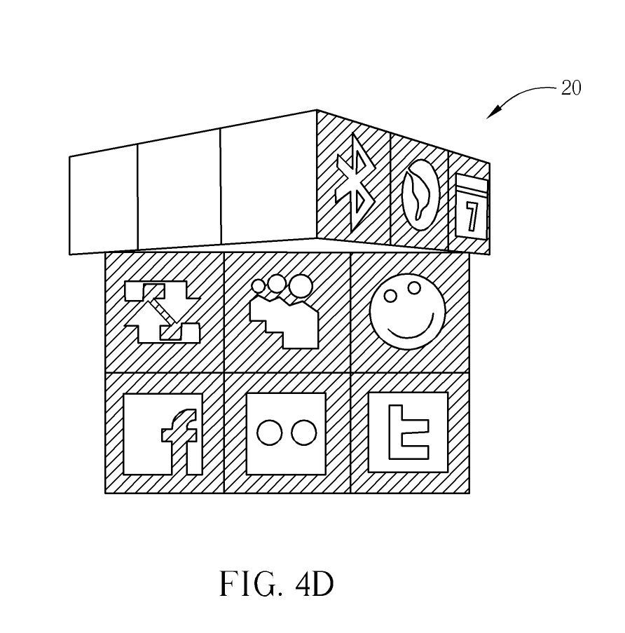

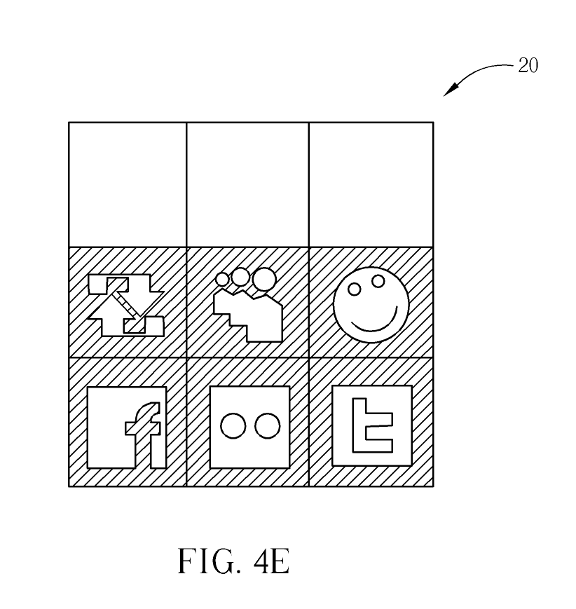

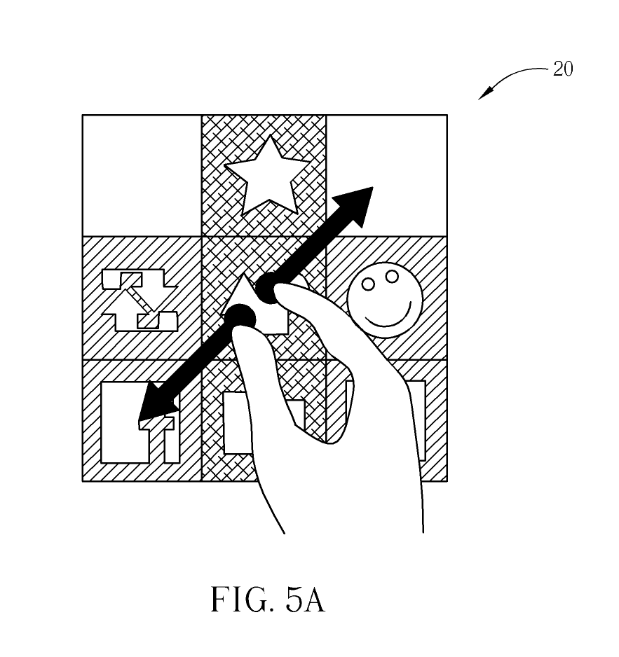

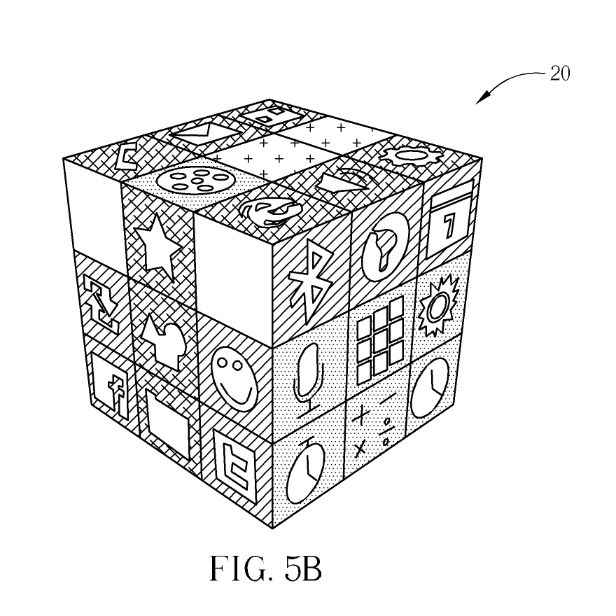

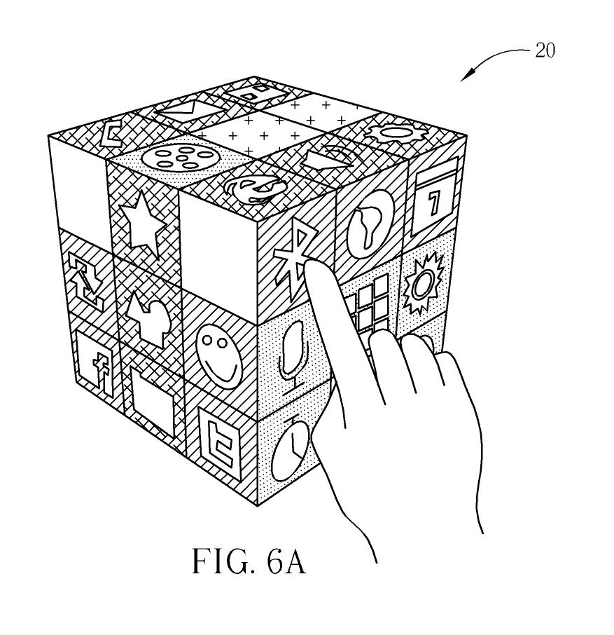

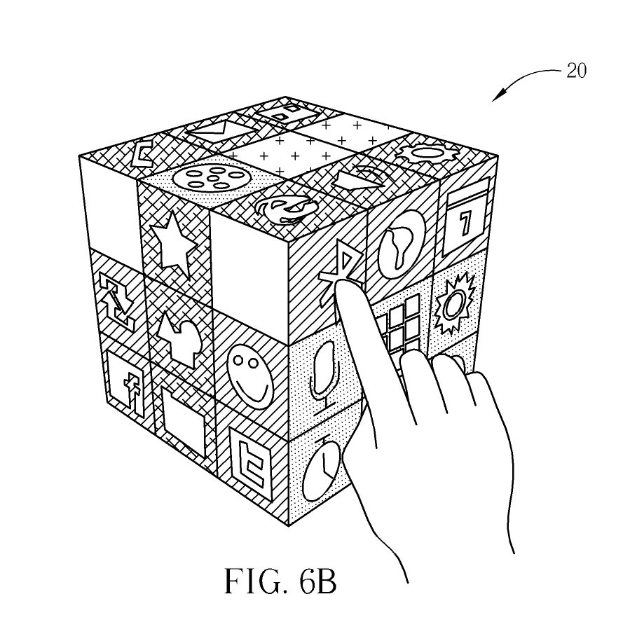

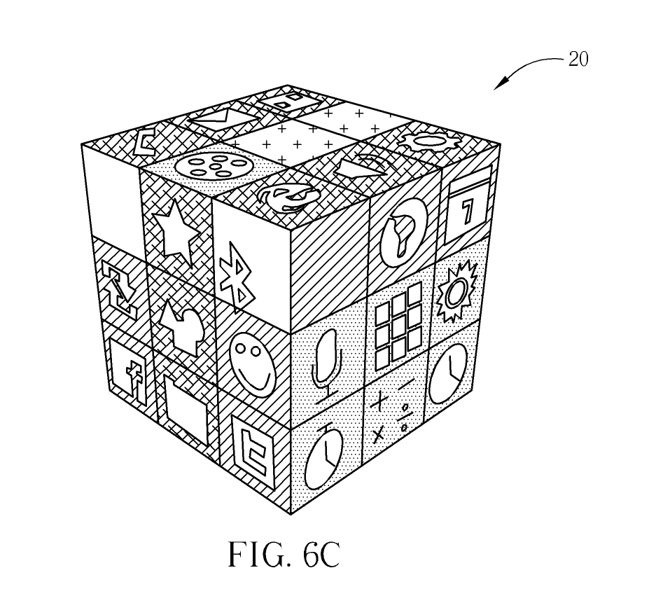

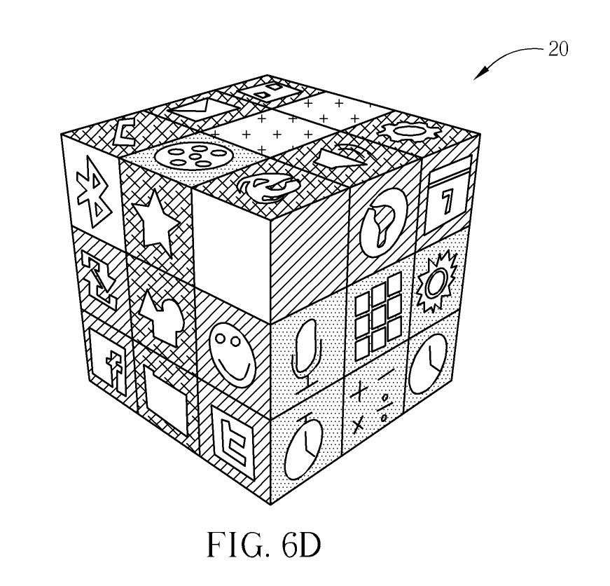

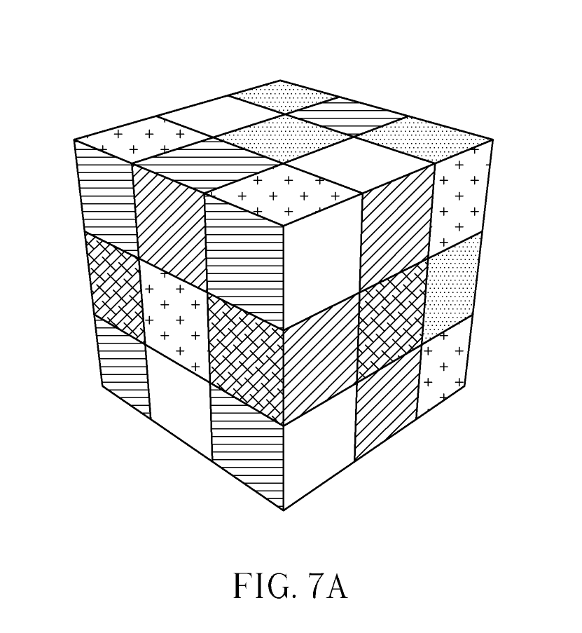

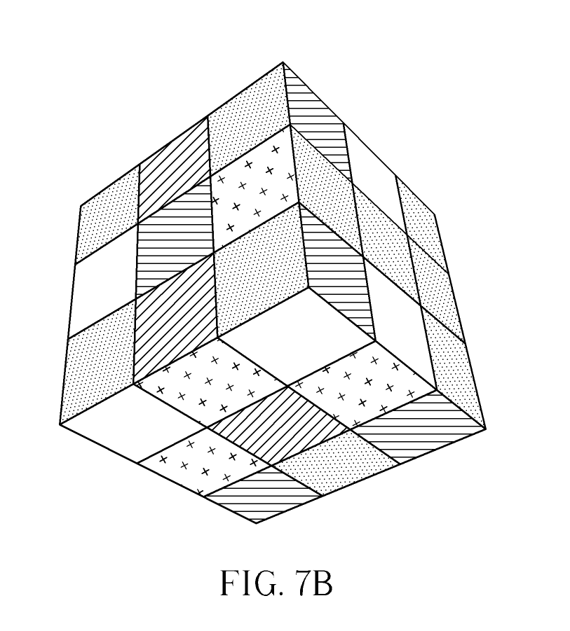

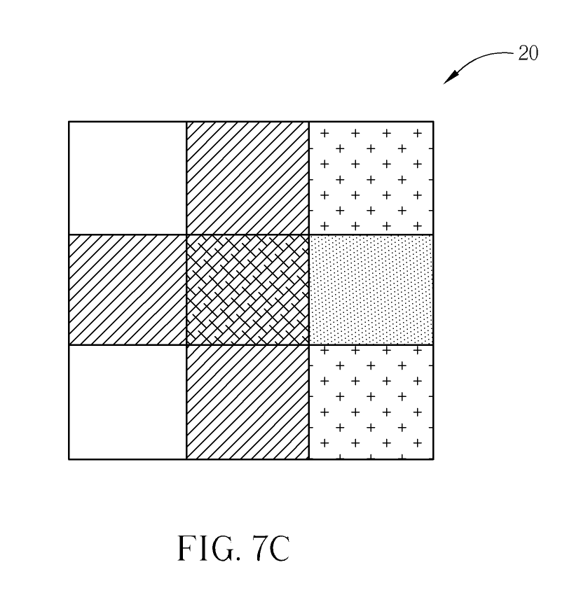

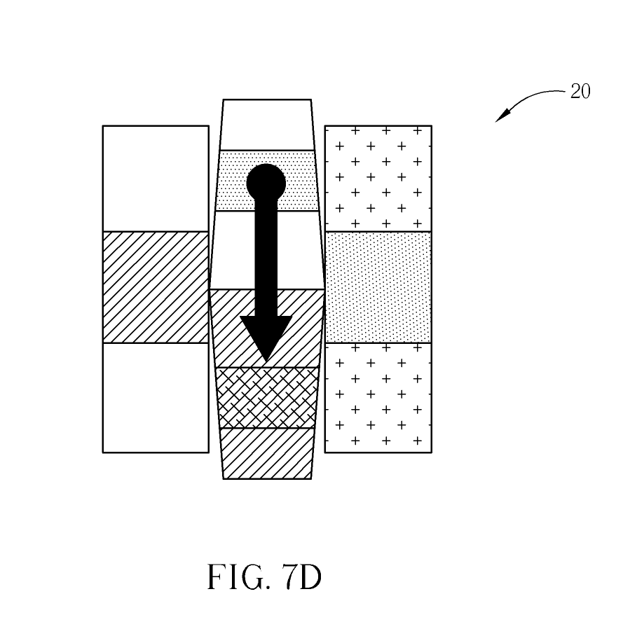

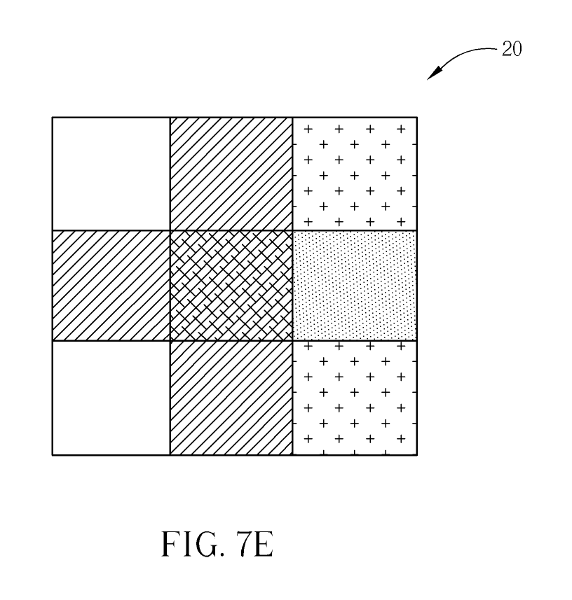

For example, as shown in FIG. 3A and FIG. 3B, when the user clicks the Rubik's Cube and slides downward, the Rubik's Cube of the user interface 20 can rotate according to the sliding direction, and selecting objects shown on the Rubik's Cube move accordingly. Moreover, a rotating speed of the Rubik's Cube of the user interface 20 can also be decided according to a sliding speed of the user. For example, when the user quickly slides, the Rubik's Cube can quickly rotate as rolling, so as to enhance interest.

In addition, as shown in FIG. 4A and FIG. 4B, when the user clicks two points and slides from inside out, a view of the Rubik's Cube of the user interface 20 can be switched from a three-dimensional view to a front view. At this moment, as shown in FIG. 4C to FIG. 4E, if the user further clicks one block and slides toward a specific direction, the user can rotate all blocks of a same column or row without affecting other blocks. Noticeably, FIG. 4C to FIG. 4E illustrate that the user slides horizontally rightward, and thus the rotated blocks are in the same row and rotate rightward. If the user slides vertically downward, the rotated blocks are in the same column and rotate downward.

After the user switches the Rubik's Cube of the user interface 20 to a front view, the user can switch the Rubik's Cube to the three-dimensional view by the same method, i.e. clicking with two points and sliding from inside out. Related operations are shown in FIG. 5A and FIG. 5B.

Moreover, as can be seen from FIG. 4C to FIG. 4E, by rotating, the user can change arrangement of the Rubik's Cube at will, so as to change locations of each selecting object. Besides, since each selecting object is an icon shown on the Rubik's Cube, locations of each selecting object can be changed by moving locations of each icon. For example, when the user attempts to move a location of a Bluetooth selecting object, the user can click and stay on the Bluetooth selecting object for a period as shown in FIG. 6A. After the period is beyond a predefined period, the Bluetooth icon floats as shown in FIG. 6B, which means the Bluetooth selecting object can be moved. Then, the user can drag the Bluetooth icon to an expected location as shown in FIG. 6C and FIG. 6D, to achieve personalized menu setting.

FIG. 6A to FIG. 6D illustrate operations of moving the Bluetooth selecting object to a blank block, i.e. a block without a selecting object. Practically, operations of exchanging locations of selecting objects can be derived from the same concept. In other words, when a selecting object is moved on another selecting object, locations of these two selecting objects are exchanged. Besides, as can be seen from FIG. 4C to FIG. 4E and from FIG. 6A to FIG. 6D, the user can achieve personalized setting by actively changing locations, background blocks of selecting objects. For example, after a specific selecting object is clicked and stayed beyond a predefined period, the selecting object can further be deleted from the corresponding blocks, or moved to another block. Certainly, in order to avoid displaying messy image, a selecting item can be added in the user interface 20, for restoring the Rubik's Cube to the initial state, i.e. all surfaces have the same color, or restoring locations of each selecting object to the initial setting.

On the other hand, other than having operating characteristics of interest, interactivity, etc., the user interface 20 can provide different operating experiences for applications such as entertainment, communication service, multimedia, etc. Taking gaming as an example, the most basic application is playing Rubik's Cube. For example, when the user clicks a selecting object corresponding to a Rubik's Cube game, the user interface 20 switches to a 3*3*3 Rubik's Cube without selecting objects, and the 3*3*3 Rubik's Cube is randomly arranged as shown in FIG. 7A. At this moment, as shown in FIG. 7B, the user can click and slide as the exemplary embodiments shown in FIG. 3A and FIG. 3B, to observe arrangement of the 3*3*3 Rubik's Cube, so as to decide following operations. After deciding how to move blocks of the 3*3*3 Rubik's Cube, the user can click two points and slide from inside out as the exemplary embodiments shown in FIG. 4A and FIG. 4B, to switch the view of the 3*3*3 Rubik's Cube from a three-dimensional view to a front view as shown in FIG. 7C. Then, as the exemplary embodiments shown in FIG. 4C to FIG. 4E, the user can click a block and slide toward a specific direction, to rotate all blocks of a same column or row without affecting other blocks as shown in FIG. 7D and FIG. 7E. Afterwards, the user can switch the 3*3*3 Rubik's Cube to the three-dimensional view as shown in FIG. 5A and FIG. 5B, so as to conveniently observe the arrangement of the 3*3*3 Rubik's Cube. By repeating the above operations, the user can experience the Rubik's Cube game. Besides, when the user plays the Rubik's Cube game, the present invention can further display a timer in the user interface 20, for counting finished time to increase challenge.

For communication service application, the user interface 20 of the present invention can utilize the Rubik's Cube to display information of multiple contacts. As known in the industry, with improvement of wireless communication, communication services provided by a smart phone have been extended from instant voice communication to wireless web surfing. Therefore, other than performing instant voice communication, the user can utilize a smart phone to perform Voice-over-IP or video call by wireless networking, or to contact with friends, leave messages or send/receive e-mails via social network tools such as Facebook, Plurk, etc. or e-mail account. In such a situation, after the user clicks a contact selecting object of the user interface 20, the user interface 20 can simultaneously display friend lists of Facebook and Plurk on three surfaces. Certainly, other than Facebook and Plurk, common social network or e-mail tools such as Myspace, Gmail, Flickr, etc. can be integrated as well. Contact lists can be most frequent contacts of the user or customized by the user. Pictures of each contact can be simultaneously updated with personal pictures of social network website. Moreover, for multimedia application, the present invention can utilize characteristics of hexahedron of the Rubik's Cube and rotation to control music player as well. For example, functions of surfaces of the hexahedron can be defined as music control buttons, music list (classified by albums), play template of ongoing music, equalizer setting, my favorite play list and frequency spectrum, respectively. Such modifications should be easily derived from the above description, and are not narrated hereinafter.

Besides, concept of the hexahedron design facilitates multi-party call. For example, for multi-party video call, video images or basic information of each incoming caller can be shown on different surfaces of the hexahedron.

Noticeably, the spirit of the present invention is to utilize the Rubik's Cube as the user interface, to enhance interest and practicality. Therefore, the above description related to applications of the user interface 20 is only utilized for illustrating plenty of variations and interesting operations of the user interface 20, and those skilled in the art should derive other applications accordingly. For example, when switching the view of the Rubik's Cube from the three-dimensional view to the front view, other than clicking two points and sliding from inside out, the user can press a specific button to achieve the same operation as well. Moreover, in the present invention, the user interface 20 is applied in a smart phone, and can be properly adjusted and applied in other electronic devices with a monitor, such as MP3 players, computer systems, etc., to achieve the same effects. For different applications, those skilled in the art should properly adjust controlled functions or operations of the user interface 20 and operating circuits of the electronic devices, such that the operating circuits can be controlled by the user interface 20. For example, when the user interface 20 is applied in a smart phone, the user interface 20 can show extra dialing shortcut buttons, or phonebook shortcut buttons, etc., and when the user interface 20 is applied in a computer system, operations of the user interface 20 can be achieved by clicking or dragging via a mouse.

On the other hand, the above description of the Rubik's Cube of the user interface 20 takes a 3*3*3 cube as example. Practically, cubes with other orders or Rubik's Cube composed of other geometric polyhedrons, such as Megaminx, Pyraminx, Square-1, Rubik's Clock, Rubik's Magic, etc., can be applied in the present invention as well. Related operations and variations can be referred to the above description.

In the prior art, the control interface of a smart phone is lack of personalized design, such that the user cannot change locations of the main menu according to personal preferences or demands, and specific functions cannot be easily found due to too many menu layers. In comparison, in the present invention, selecting objects corresponding to different functions can be shown on the Rubik's Cube at the same time, and the user can actively change locations of the selecting objects, to achieve the objective of personalization. Moreover, utilizing the Rubik's Cube as a menu interface can provide intuitive operating method with interest and interactivity, which improves user-friendliness and significantly enhances operating efficiency.

To sum up, the present invention utilizes the Rubik's Cube as the menu interface, which provides the intuitive operating method with interest and interactivity, so as to improve user-friendliness and significantly enhance operating efficiency.

Those skilled in the art will readily observe that numerous modifications and alterations of the device and method may be made while retaining the teachings of the invention.

What is claimed is:

1. A user interface for an electronic device having a monitor, comprising:
a geometric polyhedron, shown on the monitor, composed of a plurality of blocks, blocks of the plurality of blocks in a surface of the geometric polyhedron capable of rotating along a center axle of the surface; and
a plurality of selecting objects, shown on the plurality of blocks, corresponding to a plurality of functions of the electronic device.

2. The user interface of claim 1, wherein blocks corresponding to all surfaces of the geometric polyhedron have different background colors in an initial state.

3. The user interface of claim 1, wherein the geometric polyhedron can rotate along a center point.

4. The user interface of claim 1, wherein the geometric polyhedron is a cube, and each surface of the cube is composed of at least two blocks.

5. The user interface of claim 1, wherein the plurality of selecting objects are a plurality of non-filled icons shown on the plurality of blocks.

6. The user interface of claim 1, wherein the electronic device performs a function corresponding to one of the plurality of selecting objects when the selecting object is clicked.

7. The user interface of claim 1, wherein locations of a first selecting object and a second selecting object among the plurality of selecting objects are exchanged when the first selecting object is dragged on the second selecting object.

8. The user interface of claim 1, wherein one of the plurality of selecting objects is deleted from a block of the plurality of blocks when the selecting object has been clicked and stayed beyond a predefined period.

9. The user interface of claim 1, wherein one of the plurality of selecting objects is moved from a first block to a second block among the plurality of blocks when the selecting object is clicked and stayed beyond a predefined period.

10. The user interface of claim 1 further comprising a restore key shown on the monitor, for restoring the geometric polyhedron to the initial state when being clicked.

11. The user interface of claim 1, wherein the monitor is a touch control monitor.

12. An electronic device, comprising:
an operating circuit;
a monitor; and
a user interface, comprising:
a geometric polyhedron, shown on the monitor, composed of a plurality of blocks, blocks of the plurality of blocks in a surface of the geometric polyhedron capable of rotating along a center axle of the surface; and
a plurality of selecting objects, shown on the plurality of blocks, corresponding to a plurality of functions of the operating circuit.

13. The electronic device of claim 12, wherein blocks corresponding to all surfaces of the geometric polyhedron have different background colors in an initial state.

14. The electronic device of claim 12, wherein the geometric polyhedron can rotate along a center point.

15. The electronic device of claim 12, wherein the geometric polyhedron is a cube, and each surface of the cube is composed of at least two blocks.

16. The electronic device of claim 12, wherein the plurality of selecting objects are a plurality of non-filled icons shown on the plurality of blocks.

17. The electronic device of claim 12, wherein the electronic device performs functions corresponding to one of the plurality of selecting objects when the selecting object is clicked.

18. The electronic device of claim 12, wherein locations of a first selecting object and a second selecting object among the plurality of selecting objects are exchanged when the first selecting object is dragged on the second selecting object.

19. The electronic device of claim 12 further comprising a restore key shown on the monitor, for restoring the geometric polyhedron to the initial state when being clicked.

20. The electronic device of claim 12, wherein the monitor is a touch control monitor.
